(19) United States
(12) Patent Application Publication
(10) Pub. No.: US 2025/0173246 A1
(43) Pub. Date: May 29, 2025

(54) TRACE GENERATION

(71) Applicant: Arm Limited, Cambridge (GB)

(72) Inventors: Irenéus Johannes de Jong, Cambridge (GB); Sudhanshu Shekhar Jha, Lincoln (GB)

(73) Assignee: Arm Limited, Cambridge (GB)

(21) Appl. No.: 18/952,582

(22) Filed: Nov. 19, 2024

(30) Foreign Application Priority Data
Nov. 24, 2023 (GB) 2317970.8

(51) Int. Cl. G06F 11/36; G06F 11/34

(52) U.S. Cl. CPC G06F 11/3612; G06F 11/3495

(57) ABSTRACT

A method for trace generation comprises: obtaining input trace data indicative of a sequence of events occurring during execution of a target program on a processor; providing a query input to a trained generative machine learning model, where the query input is based on the input trace data; and processing the query input using the trained generative machine learning model to generate predicted trace data providing a more detailed representation of the sequence of events than is indicated by the input trace data.

The present technique relates to the field of data processing. More particularly, it relates to generation of trace data.

A data processing apparatus may have trace capture hardware for monitoring execution of a target program by a processor and outputting a sequence of trace data which indicates events occurring during execution of the target program on the processor. For example, the trace data may indicate addresses of executed instructions, outcomes of branch instructions, occurrence of exceptions, or other events of interest arising during processing of the instructions by the processing circuitry. A trace analysis unit can analyse the trace data generated by the trace capture hardware, and make deductions about operations performed by the processor when the target program was executed. This can be useful for debugging or diagnostic purposes, for example for assisting with software development.

At least some examples provide a method for trace generation, comprising: obtaining input trace data indicative of a sequence of events occurring during execution of a target program on a processor; providing a query input to a trained generative machine learning model, where the query input is based on the input trace data; and processing the query input using the trained generative machine learning model to generate predicted trace data providing a more detailed representation of the sequence of events than is indicated by the input trace data.

At least some examples provide a method for training a generative machine learning model for trace generation, the method comprising: providing a generative machine learning model defined by model parameters representing a transformation function for transforming a query input into predicted trace data, where the query input is based on input trace data indicative of a sequence of events occurring during execution of a target program on a processor, and the predicted trace data provides a more detailed representation of the sequence of events than is indicated by the input trace data; providing a training set of trace data sequences, each trace data sequence indicative of a sequence of events occurring during actual or simulated execution of a target program on a processor; and applying a training function to train the generative machine learning model using the training set of trace data sequences, to generate updated values for the model parameters.

At least some examples provide a program comprising instructions which, when executed on a data processing apparatus, cause the data processing apparatus to perform either of the methods described above. The program may be stored on a recording medium. The recording medium may be a non-transitory recording medium.

At least some examples provide an apparatus comprising: input circuitry to obtain input trace data indicative of a sequence of events occurring during execution of a target program on a processor; and processing circuitry to provide a query input to a trained generative machine learning model, where the query input is based on the input trace data, and process the query input using the trained generative machine learning model to generate predicted trace data providing a more detailed representation of the sequence of events than is indicated by the input trace data.

Further aspects, features and advantages of the present technique will be apparent from the following description of examples, which is to be read in conjunction with the accompanying drawings, in which:

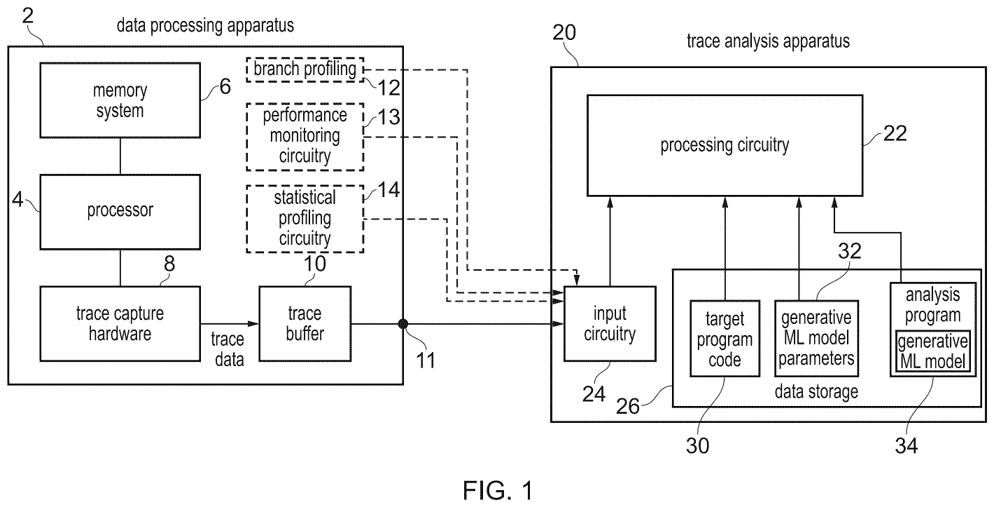

FIG. 1 illustrates an example of capturing trace data during execution of a target program by a processor and analysing the trace data;

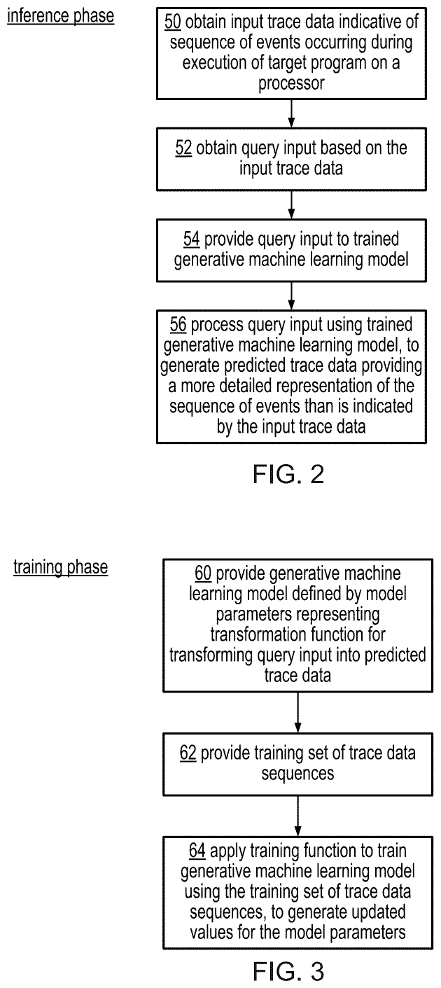

FIG. 2 illustrates an example method for an inference phase of processing a query input using a generative machine learning model, to generate predicted trace data providing a more detailed representation of events than the input trace data on which the query input is based;

FIG. 3 illustrates an example method for a training phase of the machine learning model;

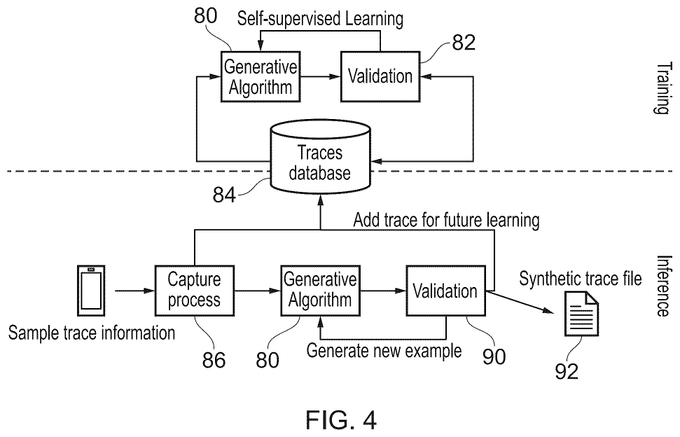

FIG. 4 illustrates an example approach for generating trace data using a generative machine learning model;

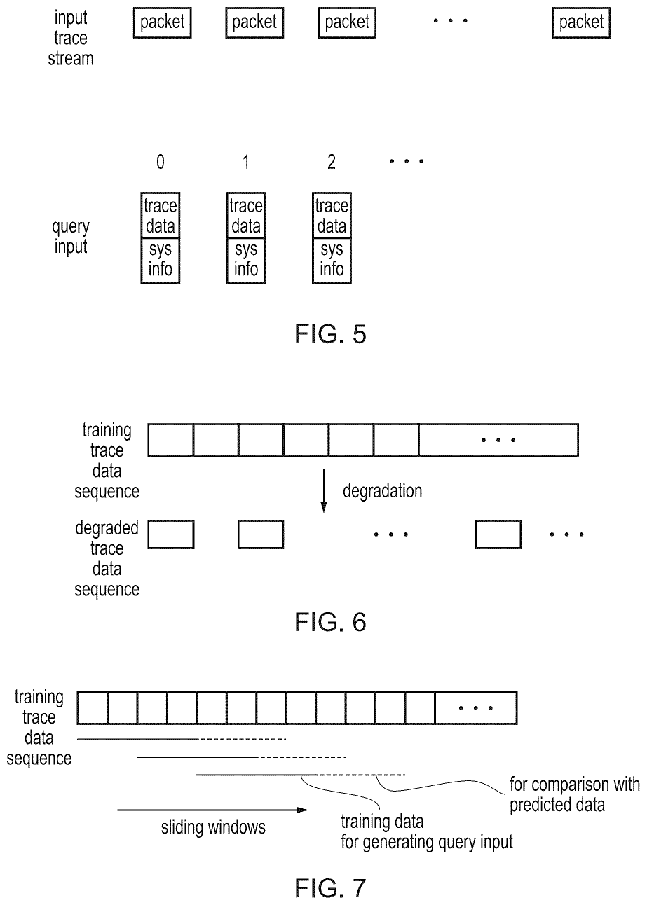

FIG. 5 illustrates an example of a query input comprising trace data and system information;

FIG. 6 illustrates an example of generating a degraded trace data sequence from a training trace data sequence;

FIG. 7 illustrates an example of a sliding window approach to training the model for predicting future trace data of a trace sequence based on past trace data of the trace sequence;

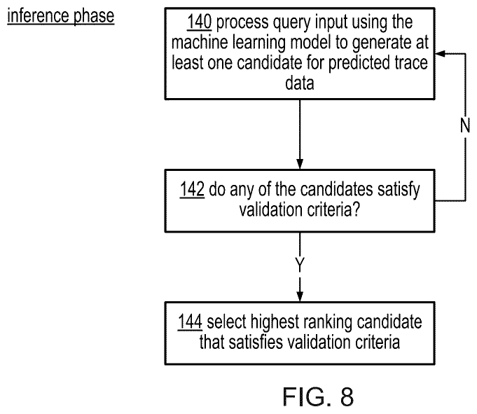

FIG. 8 illustrates an example of, during the inference phase, applying one or more validation criteria when generating the predicted trace data;

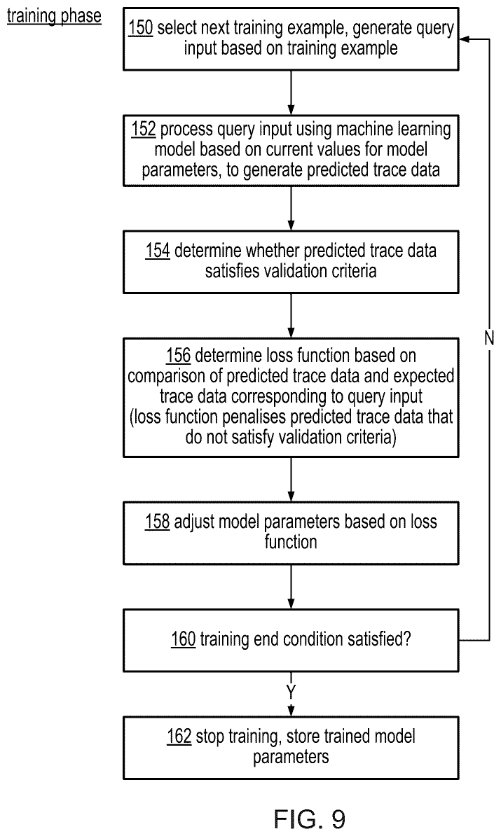

FIG. 9 illustrates an example of, during the training phase, adjusting the model parameters based on whether predicted trace data satisfies the validation criteria;

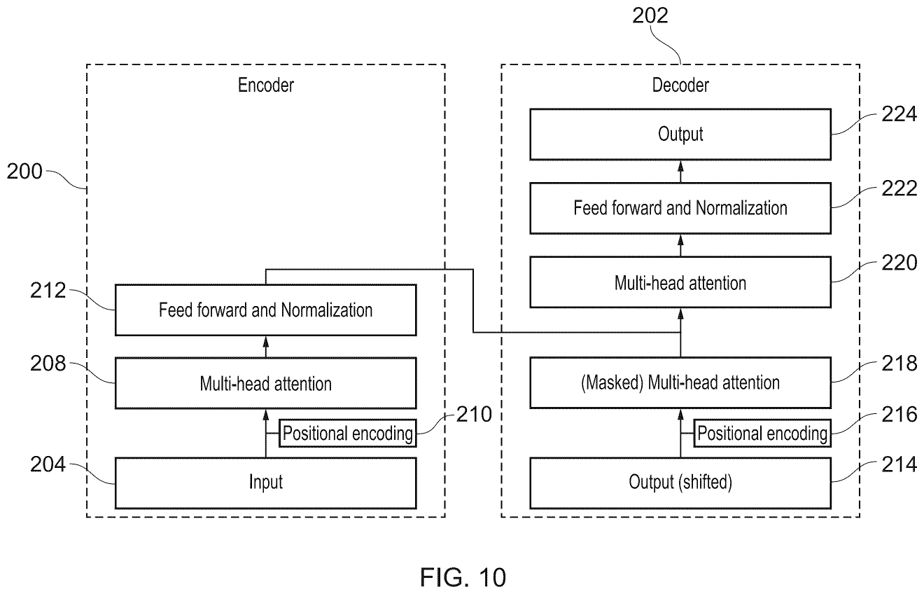

FIG. 10 illustrates an example of a transformer model that is one example of a machine learning model that could be used to generate trace data;

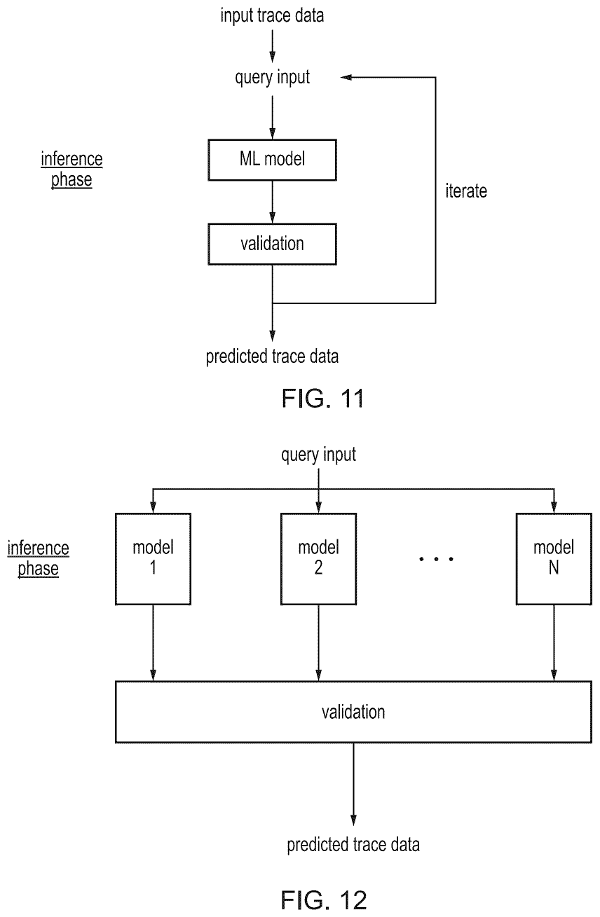

FIG. 11 illustrates generating the predicted trace data by using multiple iterations of querying a machine learning model; and

FIG. 12 illustrates an example of using two or more machine learning models to generate respective candidates for the predicted trace data using the same query input.

Tracing can be an important tool for performance analysis and system evaluation, for assisting with development of software. A trace capture module may monitor activity of a processor when executing a target program, and generate trace data representing the sequence of events that occurred when the target program is executed. Subsequent analysis of the trace data may help a software developer to identify bugs, performance issues or code improvements for the software.

There are multiple different ways to capture and record traces depending on the detail and level of complexity that needs to be captured. However, it is not always possible to capture a detailed trace. For instance, a trace may get too expensive to record and store simply because too many details need to be recorded. Therefore, the inventors recognised that, in practice, a stream of trace data generated by trace capture hardware associated with a processor may be incomplete, in that it represents a sampled subset of the events which actually happened. This means some information is lost which could have been useful for diagnostic analysis.

In examples discussed further below, a method for trace generation comprises: obtaining input trace data indicative of a sequence of events occurring during execution of a target program on a processor; providing a query input to a trained generative machine learning model, where the query input is based on the input trace data; and processing the query input using the trained generative machine learning model to generate predicted trace data providing a more detailed representation of the sequence of events than is indicated by the input trace data.

Recent developments in generative machine learning approaches have shown that methods like transformer Models and diffusion models are great at generating representative data points based on sparse samples. They can capture realistic patterns and apply them to create examples that are indistinguishable from real examples. The inventors have recognised that such a generative machine learning model can be applied to sparse input trace data, to generate more detailed predicted trace data, so that the limitations of the trace capture sampling can be overcome and more detailed diagnostic information can be obtained that could not otherwise be collected given any hardware limitations on sampling rate, trace output bandwidth etc. This is helpful to support more detailed diagnostic analysis of system operation when executing a target program. It may seem surprising that a generative machine learning model could be useful for synthetic trace generation, as one would think that it could not be guaranteed that the predicted trace data actually matches the underlying reality of what happened during execution of the target program. However, in practice the inventors recognised that the risk of “hallucination” can be mitigated against, and in any case for many diagnostic use cases it is sufficient to generate a trace that is representative of a real workload, even if not a perfect match to the underlying reality of what happened during program execution. Therefore, surprisingly it is useful to apply generative machine learning to sparse input trace data to generate more detailed predicted trace data, especially in scenarios where capturing detailed trace in the original input trace data would be too expensive or impossible. Also, by supporting such machine learning based technique, it becomes feasible to use less sophisticated hardware for trace capture than would otherwise be possible, allowing circuit designers to reduce the circuit area and power budget expended on trace capture hardware (e.g. smaller trace buffers or fewer trace I/O pins may be sufficient to generate trace data at a given level of detail, as it is possible for the trace hardware to capture less detailed trace data which is then expanded using the machine learning approach after being captured).

In some examples, the input trace data is indicative of a sampled subset of events occurring during execution of the target program on the processor, and the trained generative machine learning model predicts missing events that occurred during execution of the target program but were omitted from the input trace data due to sampling. The sampling could be a deliberate sampling, where to conserve trace bandwidth the trace hardware determines to generate trace data only for a subset of occurrences of a particular event. Alternatively, the sampling could be accidental sampling, where there may be an unplanned need to drop some captured trace data for some occurrences of events of interest due to lack of trace bandwidth (e.g. running out of space in a trace buffer, or insufficient bandwidth being available on a trace bus or port). Regardless of the cause of the sampling, the machine learning model can be useful to predict some events which occurred but were missing from the trace stream due to the sampling.

The trace data could represent a wide variety of types of events that may occur during program execution. However, the technique can be particularly helpful where the input trace data comprises instruction trace data providing program flow information indicative of which instructions were executed during execution of the target program on the processor. For example, the input trace data may track occurrences of taken branch instructions (e.g. by providing branch trace packets indicating taken/not-taken outcomes for a series of branches, or by tracking instruction/target addresses of the branches). The input trace data could also specify a series of instruction addresses of executed instructions.

The input trace data may comprise trace data captured using trace capture hardware configured to monitor operation of the processor during execution of the target program. The trace capture hardware may comprise on-chip trace capture hardware on the same integrated circuit as the processor, or could comprise off-chip trace capture hardware which is on a different integrated circuit to the processor. The step of obtaining the input trace data could comprise actually capturing the input trace data using the trace capture hardware, or could comprise reading input trace data that was captured earlier by trace capture hardware (with the trace capture hardware possibly being on a different device to the device performing the method for trace generation). For example, the input trace data could be obtained via an input/output (I/O) port of the device performing the method for trace generation, or could be read from data storage of the device performing the method for trace generation, having previously been captured using trace capture hardware associated with the processor and supplied to the I/O port or data storage. Hence, it is not essential for the capture of the input trace data using the trace capture hardware to occur at the time that the method of trace generation is performed, and in some cases the input trace data may have been captured in advance, offline from the method of using the trained machine learning model.

As well as comprising information derived from the input trace data itself, the query input may also comprise system information captured during execution of the target program on the processor. For example, while the trace data may capture a sequential series of packets representing a sequence of events occurring during program execution, the system information could provide other ancillary information. For example, the system information could include:
synchronisation information for synchronising items of trace data of the input trace data with a point of execution of the target program (e.g. timestamps or instruction addresses which can represent a synchronisation point relative to which a trace analyser can deduce which trace packets relate to which instructions, and/or instruction count values each representing a measure of the number of executed instructions since a previous reference point, any of which can provide information for synchronising the trace stream with a point of program execution).
performance monitoring information captured by one or more performance monitoring counters of the processor during execution of the target program on the processor (e.g. counts of the number of load/store operations, cache misses, branch mispredictions, etc.), and/or profiling information indicative of system behaviour associated with execution of a sampled instruction selected for profiling (e.g. tracking whether that instruction caused a cache hit/miss, translation table walk due to a miss in a translation lookaside buffer, or caused an exception to be signalled);
branch statistic information providing a statistical measure of behaviour of branch instructions of the target program (e.g. a fraction of branches which are taken, or the fraction of instructions which are branches within a certain block of instructions), and/or branch target address information indicative of target addresses of branches taken during execution of the target program.
   By including additional system information in the query input, the machine learning model can be given additional context to the trace data itself, which can be helpful for making more informed inferences. This can increase the likelihood that the predicted trace data is realistic for the executed target program.

For example, to enable consideration of system information, the query input to the machine learning model can be formatted as a sequence of vectors, each vector comprising an item of trace data from the input trace data and at least one system information field for associating at least one item of system information with that item of trace data. The machine learning model may have a layer which can take as an input masking information indicating which items of the vectors are blank for a given point in the sequence, so that it is not necessary that each vector has valid system information associated with it for all system information fields.

Alternatively, the system information could be interleaved with the trace data, to form a single sequential stream of information which is processed as the query input.

One problem that can arise with generative machine learning models is that they can hallucinate examples that are not realistic. One might think this might risk the predicted trace data not being useful. However, the inventors recognised that this can be addressed by including a validation step after the predicted trace data is generated. The method may comprise validating whether the predicted trace data meets at least one validation criterion for checking whether the predicted trace data is realistic. In response to determining that one or more items of predicted trace data generated by the model each fail the at least one validation criterion, the query input can be re-processed using the trained generative machine learning model to generate one or more new instances of the predicted trace data. Hence, the model can be repetitively applied to the same query input until some predicted trace data is generated which meets the validation criteria.

While one might think that such repetitive generation of predicted trace data may be inefficient, in practice many generative machine learning models may, as a function of their prediction algorithm, rank a number of candidates for the predicted output and so have available multiple candidates that could be selected as the actual prediction. Hence, in some examples it can be useful to apply the at least one validation criterion to more than one prediction candidate generated from the query input by the generative machine learning model, and then select as the predicted output the highest ranked candidate which satisfies the at least one validation criterion (even if that candidate was initially outranked by another candidate which did not satisfy the at least one validation criterion). This can reduce the processing time involved in running the model, as by validating multiple candidates for each prediction run it is more likely that a successfully validated candidate can be found earlier, reducing the number of runs needed to generate representative predicted trace data.

A wide variety of validation criteria could be used, either individually or in combination. A number of checks can be implemented, referencing information that may be available at the time of trace analysis, to verify whether the predicted trace data could be representative of the real system operation during execution of the target program.

For example, the at least one validation criterion may include an input preservation criterion to determine, based on a comparison of the input trace data and the predicted trace data, whether the input trace data has been preserved within the predicted trace data. This recognises that, unlike many generative machine learning problems where there is no indication of any particular symbols to be included in the predicted trace stream, for the problem of restoring trace elements missing from sparsely sampled trace data, those elements that were output in the input trace data are reliable indications of occurred events and should preferably be retained in the prediction. Preferably, the prediction by the machine learning model should add to those trace elements of the input trace data, rather than taking away some of those trace elements. Therefore, a prediction which eliminates or does not include some of the actually generated elements of the input trace data would typically be less useful than a prediction which retains the elements of the input trace data. Hence, by comparison of the input trace data and the predicted trace data it is possible to evaluate the extent to which the input trace data is still present in the predicted trace data, and eliminate candidate predictions which do not preserve the input trace data in the predicted trace data.

Another example of a validation criterion includes a source code criterion to determine, based on source code of the target program, whether the sequence of events indicated by the predicted trace data is consistent with a realistic program flow path that could be taken when executing the target program defined by source code. In many tracing approaches, the trace stream does not necessarily include an indication of every instruction that executed, and instead tracing of branch points may be sufficient to allow a trace analyser to deduce which instructions were executed from a combination of the trace stream and a copy of the source code of the target program. Hence, the source code of the target program is typically available to the trace analyser already. By comparing the source code with the predicted trace data, determinations can be made of whether the predicted trace data can be representative of an instance of executing that source code. For example, if the predicted trace data records a greater number of branches as occurring between two synchronisation points than would be possible given the source code, or indicates that two instructions were both executed despite those instructions not being possible to be executed together as they depend on mutually exclusive conditions, then a comparison with the source code can identify the unrealistic trace data and cause this example of the predicted trace data to be eliminated from consideration.

Another example of a validation criterion includes a performance monitoring counter criterion to determine, based on at least one performance monitoring count value indicative of frequency of a given event during execution of the target program, whether the sequence of events indicated by the predicted trace data is consistent with the at least one performance monitoring count value. For example, the given event could be the processing of a branch instruction (or more particularly a taken branch instruction), the processing of a load/store instruction, the occurrence of a cache miss or translation lookaside buffer miss, etc. Again, if the trace data indicates a sequence of events that could not possibly have occurred given the performance monitoring counter values (e.g. the trace data records more branches than were counted by the performance monitoring circuitry), then the predicted trace data can be discarded and the prediction re-tried (or another candidate selected if there is one available that meets the validation criterion).

Another example can be where the at least one validation criterion includes an instruction composition criterion to determine, based on instruction composition information indicative of relative frequency of one or more types of instruction among the instructions executed for the target program, whether the sequence of events indicated by the predicted trace data is consistent with the instruction composition information. If the instruction composition information indicates a relatively high or low rate of occurrence of one particular type of instruction (e.g. branches, load/store instructions or compute instructions) but the predicted trace data indicates a rate of occurrence that is significantly different to the rate indicated by the instruction composition information, the predicted trace data may be considered unrealistic and so not pass the validation test.

Another example of the at least one validation criterion includes a branch target criterion to determine, based on branch target information indicative of target addresses of taken branch instructions executed for the target program, whether the sequence of events indicated by the predicted trace data is consistent with the branch target information. For example, information on the branch target addresses of taken branches may be recorded (either by dedicated hardware, or with assistance from software such as an operating system), and the branch target address information can be made available to the trace analyser for correlation with the predicted trace data. If the predicted trace data does not fit with the pattern of branch target addresses indicated by the branch target information, it can be rejected as failing the validation.

Another validation test could be based on an indication of a current operating state of the processor associated with a portion of the input trace data. For example, the current operating state may indicate a current mode, security state, exception level or privilege level associated with the processor at the time it executed the instructions indicated by that portion of the input trace data. If a corresponding portion of the predicted trace data (e.g. a portion which relates to the same portion of program execution as the portion of input trace data associated with the current operating state indication) is determined to indicate events that would not be allowed in the current operating state then the predicted trace data can be considered invalid as it is unrealistic. For example, an indication in the predicted trace data that an access to a privileged register reserved for access in states of higher privilege could be considered not allowed if the current operating state is an operating state with lower privilege.

Hence, by applying validation the risk of hallucination can be reduced and the likelihood that representative trace can be generated can be increased.

In some examples, the predicted trace data may be generated through multiple iterations of processing by the trained generative machine learning model, where output trace data generated for a given iteration of processing is input as the query input for a further iteration of processing by the trained generative machine learning model. If there is a lot of missing trace data to be predicted, it can be less error prone to predict a smaller amount of missing trace data in each pass of the machine learning model, and then use multiple runs of the machine learning model to gradually build up more trace data. For example, this can allow validation to be applied after each iteration to reduce risk of invalid trace data being propagated to further steps. Hence, the output trace data generated for the given iteration of processing may be validated to check whether it meets at least one validation criterion for checking whether the output is realistic, before inputting the validated output trace data as the query input for the further iteration.

In some examples, a single trained generative machine learning model can be used.

However, other examples may provide two or more trained generative machine learning models, which are based on different prediction functions (e.g. a transformer function and a recurrent neural network function) and/or different sets of training data (e.g. a first model trained on trace data for compute-heavy workloads where the ratio of computation instructions to memory access instructions is relatively high and a second model trained on trace data for memory-heavy workloads where the ratio of computation instructions to memory access instructions is relatively low). The same query input may be processed using each of the trained models, and the method may comprise selecting between predicted trace data generated by at least two of the trained generative machine learning models supplied with the same query input, based on validation of the outputs of said at least two of the trained generative machine learning models. By having a variety of models available which may have different strengths and weaknesses, and applying the validation to each model, it is more likely that a realistic prediction of the missing trace data can be generated from a sparse input stream.

A wide variety of types of machine learning models can be used for the trace generation. For example, the trained generative machine learning model may comprise at least one of: a diffusion model; a transformer model; a recurrent neural network; a long short-term memory model; and a Markov model.

The generative machine learning model may be trained based on a training set of trace data sequences, in advance of the model being used in an inference phase to make predictions of trace data. Hence, the training phase is not necessarily performed by the same party who performs the inference phase, and so is not an essential feature of the inference phase processing. The inference phase may be performed based on a pre-trained model defined by static model parameters learnt previously when the model was developed.

Alternatively, in some cases training may continue during the inference phase processing, with new input trace data examples provided to generate query inputs for trace prediction also being added to the trace database of trace data sequences and being used to continue adaptation of model parameters by machine learning.

Hence, regardless of whether the training is performed in advance or continues in parallel with the trace generation, a method is provided for training a generative machine learning model for trace generation. The method comprises: providing a generative machine learning model defined by model parameters representing a transformation function for transforming a query input into predicted trace data, where the query input is based on input trace data indicative of a sequence of events occurring during execution of a target program on a processor, and the predicted trace data provides a more detailed representation of the sequence of events than is indicated by the input trace data; providing a training set of trace data sequences, each trace data sequence indicative of a sequence of events occurring during actual or simulated execution of a target program on a processor; and applying a training function to train the generative machine learning model using the training set of trace data sequences, to generate updated values for the model parameters.

The training set of trace data sequences can be obtained in different ways. Some trace data sequences may be captured by real trace hardware on a real processor. For example, a processing system could be selected which has particularly high-bandwidth trace infrastructure (e.g. a particularly large trace buffer or large number of pins for outputting trace data off-chip), so that a set of trace data can be captured which is likely to support more detailed indication of events occurring during program execution than would be practical to collect on many other processor designs with lower bandwidth available for trace collection and output. Alternatively, training sequences of trace data may be synthesized artificially, or obtained by simulating the processing of a program on a target processor. Cycle-accurate simulations of processor designs are available which can simulate, in software executing on a general-purpose computer, the operation of a particular processor design. Such software could therefore also generate a sequence of trace data representing the events which occurred when a given program is executed on the simulator. Alternatively, software can synthetically generate a representative trace stream without actually simulating program execution. It may be that, by providing synthetic or simulated trace streams as training data, it is more feasible to be able to capture events in higher detail than would be practical given hardware limitations of a hardware capture system, so the synthetic or simulated trace streams can be useful for providing higher quality training data sets.

The training function of the model may operate in different ways. In some examples, more detailed training trace data sequences may be degraded to generate sparser sets of trace data which can be used to form the query input to be supplied to the model during the training phase. Hence, the method of training may comprise generating, for each trace data sequence of the training set, one or more degraded trace data sequences representing the sequence of events in less detail than that trace data sequence. The training function may comprise, for a given degraded trace data sequence: applying the transformation function to the given degraded trace data sequence, to generate a given predicted trace data sequence; and adjusting the model parameters based on a comparison of the given predicted trace data sequence with a corresponding trace data sequence of the training set from which the given degraded trace data sequence was derived. For example, a diffusion process may be used to apply noise to the training data to generate the degraded trace data sequences, and the model may be trained to denoise the input and restore the missing trace information lost in the diffusion process.

In some examples, the training function comprises, for a given trace data sequence of the training set: applying the transformation function to a window of trace data from the given trace data sequence, to generate predicted trace data for a following window; and adjusting the model parameters based on a comparison of the predicted trace data for the following window with actual trace data indicated by the given trace data sequence for the following window. A sliding window approach can be used so that a single sequence of trace data may effectively provide many items of training data, as each successive sliding window effectively represents a new example for training even though it was derived from the same original trace stream.

In some examples, the training function is dependent on an outcome of validating whether the predicted trace data meets at least one validation criterion for checking whether the predicted trace data is realistic. For example, any of the validation criteria described above for the inference phase processing may also be used during the training phase. It is not essential for the validation criteria to be the same during training and inference—some additional criteria could be applied during inference based on information that might not be available for training. Nevertheless, by including at least one validation criterion during training, and biasing the training of the model parameters so that predictions which fail the validation criteria are penalised in comparison to predictions which pass the validation criteria, it is more likely that the model can be refined during training to generate more useful predictions which are more likely to pass validation in the inference phase.

The methods discussed above can be implemented based on software executing on a processor. Hence, a program may be provided to control a computer to perform any of the methods discussed above. The program may be stored on a computer-readable storage medium. The storage medium may be a non-transitory storage medium.

Also, a hardware device may be provided to perform trace analysis, and the hardware device may be implemented with circuitry for implementing the machine learning model. Hence, an apparatus may comprise input circuitry to obtain input trace data indicative of a sequence of events occurring during execution of a target program on a processor; and processing circuitry to provide a query input to a trained generative machine learning model, where the query input is based on the input trace data, and process the query input using the trained generative machine learning model to generate predicted trace data providing a more detailed representation of the sequence of events than is indicated by the input trace data.

Specific examples will now be described with reference to the drawings.

FIG. 1 schematically illustrates an example of a system comprising a data processing apparatus 2 and the trace analysis apparatus 20. In some examples, the trace analysis apparatus 20 may be a local device disposed at the same physical location as the data processing apparatus 2. Alternatively, the trace analysis apparatus 20 could be at a remote location separate from the location of the data processing apparatus 2, with data passing from the data processing apparatus 2 to the trace analysis apparatus 20 via a network.

The data processing apparatus 2 may, for example, be a computing device or system-on-chip, which comprises at least one processor 4 for executing program instructions of a target program. A memory system 6 stores the program code of the target program and data to be processed by the target program.

In a typical processing device, without the provision of on-chip trace collection hardware, it can be difficult for a software developer to understand the reasons for functional problems or performance issues arising when a target program executes on the processor 4, because the internal signal paths of the processor are not accessible from outside the chip and hardware limitations in the number of external I/O pins on the chip mean that it is not practical to expose a large amount of internal processor state for access outside the chip. To address this issue and provides some diagnostic resources which can allow software developers to understand the path of program flow taken by the program when executed on the processor 4 and identify other events of interest that occurred during program execution, trace capture hardware 8 may be provided to monitor activity of the processor 4 and generate a sequential stream of trace data which represents the sequence of events that occurred during program execution. The trace data may initially be written to an on-chip trace buffer 10, and may be read out from the buffer 10 to an off-chip location via an I/O port 11. The trace data may comprise a stream of trace packets (also known as trace “elements”), with each element representing an event (or group of events) that occurred during program execution or indicating other information about the point in program flow reached during program execution or status information about the status of the processor at a given point of program flow. For example, the trace data may include elements indicating any of:
outcomes of branch instructions (taken or not-taken), which can be helpful for deducing the path of program flow taken by the processor when executing the target program for which diagnostic analysis is desired;
addresses of a subset of instructions executed by the processor;
branch target addresses of taken branches, indicating the address of the first instruction executed after each branch was taken;
synchronisation information which may allow identification of the point of program flow corresponding to a particular location in the trace stream. This allows deduction of which instructions relate to other trace elements of the trace stream. For example, the synchronisation information could include a timestamp (based on a processor clock for example), an instruction address representing an instruction executed at a point of program flow corresponding to the synchronisation element of the trace stream, and/or a count of the number of instructions executed since a previous synchronisation packet was included.
addresses of data accessed by load/store operations performed to memory;
occurrence of exceptions or exception returns;
occurrence of branch mispredictions or other mis-speculation events.
context information indicating a current operating state of the processor 4 when executing instructions associated with a given portion of the trace stream.
   Clearly, a wide variety of other information could also be included in the trace stream. It is not essential for every executed instruction to be represented explicitly in the trace stream, as to reduce the volume of data generated it may be sufficient to identify the outcomes of branch instructions, which can be enough to allow a trace analyser (having a copy of the program code) to deduce which other instructions were executed in a sequential run of program execution between successive branches.

The data processing apparatus 2 could also have a number of other types of diagnostic hardware which could be used to provide additional diagnostic information of use for identifying problems arising during program execution. For example, the data processing apparatus may have branch profiling circuitry 12 for generating branch statistics representative of properties of branch instructions executed within the target program. For example, the branch profiling circuitry 12 may track statistics such as the fraction of executed instructions which are branch instructions, the fraction of branch instructions which are taken or not-taken, the fraction of branch predictions which are successful or mispredicted, etc.

Another example of additional diagnostic circuitry may be performance monitoring circuitry 13 which comprises a number of performance counters implemented in hardware, which are configurable by software to count occurrences of a particular event (the software may configure parameters defining which type of event is to be counted by each counter). For example, the performance monitoring circuitry 13 may support the event type counted by a given performance counter being any one of a variety of events, such as a clock cycle elapsing, an instruction being executed, a load/store operation being performed, a cache miss occurring in a given level of cache, a page table walk being required following a miss in a translation lookaside buffer (TLB), a memory management fault occurring due to an attempt to access memory which violates access permissions, etc. A readout mechanism may be provided to allow software to trigger readout of current values of performance counters, with the performance count values being stored to memory 4 and/or output off-chip. Unlike the trace data, such performance count values may not correlate the counted events with any particular point of program flow, but may provide a general measure of processing performance achieved for the program being executed.

Another example of diagnostic circuitry may be statistical profiling circuitry 14 which generates, for a sampled subset of executed instructions, a profiling record for each sampled instructions providing information defining the specific system behaviour of the processor attributed to the processing of that instruction. For example, the profiling record could indicate the outcome of the instruction (e.g. for a branch, whether the branch was taken or not taken or mispredicted, or for a load/store instruction whether the load/store was successfully executed or triggered a memory fault). The profiling record could also indicate information on the number of cycles taken to process the instruction. When the sampled instruction is a load/store instruction, the profiling record for that instruction may represent the address that was accessed by that instruction, whether the load/store hit or missed in a cache, and/or whether the instruction required a page table walk to fetch in page table data or hit in a TLB caching previously obtained page table information. Unlike the trace data generated by the trace capture hardware 8, the profiling records generated by the statistical profiling circuitry 14 do not attempt to provide information which would enable reconstruction of the program flow taken during execution of the program. However, by providing information on selected sampled instructions (which may be selected based on a sampling counter to periodically select an instruction to sample), it becomes feasible to record more detailed information about each sampled instruction than would be possible in a trace stream. The profiling records captured by the statistical profiling circuitry 14 may therefore provide a statistical view of issues arising within the program, which can be useful for diagnostic purposes even if they do not attempt to capture a complete record of program execution. The profiling records may be written to the memory system 2 and can subsequently be read out to an external device via an I/O port.

The trace analysis apparatus 20 includes input circuitry 24 suitable for inputting trace data into the trace analysis apparatus that was generated by capture using the trace capture hardware 8 of the data processing apparatus, and processing circuitry 22 suitable for processing the trace data using a generative machine learning model. For example, the input circuitry 24 can be an I/O port via which data can be supplied to the trace analysis apparatus 20 from an external device or network. Although FIG. 1 shows the trace data passing direct from the data processing apparatus 2 to the trace analysis apparatus 20, it is also possible for intervening devices to process the trace data between being output by the data processing apparatus 2 and input to the trace analysis apparatus 20. The trace analysis apparatus could be a dedicated integrated circuit specifically designed for analysing trace data, or could be a general purpose computing device executing trace analysis software. In the example shown in FIG. 1, the processing circuitry 22 executes an analysis program 34 defined in data storage 26 of the trace analysis apparatus 20, but it will be appreciated that trace analysis functions could also be implemented in hardware using specific integrated circuit logic. The trace analysis can be performed with reference to a copy of the program code 30 defining the target program which was executed on the data processing apparatus 2. For example, the branch outcomes indicated by the trace stream and synchronisation markers included in the trace stream may be used to deduce which paths of program flow were taken through the program and could be used to generate hot-spot information identifying frequently executed portions of the program which might be better candidates for performance optimisations than other less frequently executed portions, if there is limited development time available for investigating performance issues and adapting the code to address them. Based on automated, semi-automated or manually-driven analysis of the sequence of events that occurred during execution of the target program, a developer can diagnose problems with the software and identify possible code fixes to resolve those problems.

While system tracing is an important tool for performance analysis and system evaluation, it is not always possible to capture the trace data in as much detail as would be desired for diagnostic purposes. The trace buffer 10 and trace port 11 may support a limited bandwidth, and the high clock frequencies and instruction execution rates supported by modern processors mean that generating a complete trace may generate unfeasibly high volumes of trace data if the trace data is not sampled in some way. Hence, in practice, the trace capture hardware 8 may have to limit what types of information are captured or the frequency at which information is sampled for trace output. Also, sometimes if the trace buffer 10 overflows then some useful trace data may be lost. Hence, for a variety of reasons the output trace stream may be relatively “sparse” in the sense that it does not provide all the information of interest but represents selected snapshots of a sequential series of events occurring during program execution. However, a developer may find the level of detail output in the trace data insufficient for their diagnostic purposes. It may be desirable to be able to generate more detailed trace streams than is typically feasible given the hardware resources provided for the trace capture hardware 8.

This problem is addressed by providing the processing circuitry 22 of the trace analysis apparatus 20 with support for executing a trained generative machine learning (ML) model, defined by associated model parameters 32, which is used to process the relatively sparse sets of trace data output by the trace capture hardware 8, to generate predicted trace data which provides a more detailed representation of the events occurring during execution of the target program on the processor 4. In the example in FIG. 1 the machine learning model is implemented as part of the trace analysis program 34, but in other examples the machine learning model could be a separate piece of software from the trace analysis program 34, or the machine learning model could be implemented using dedicated hardware referencing the stored model parameters 32 to carry out inference phase functions based on the model parameters 32 which have been previously trained for trace generation based on training sets of trace data. Also, while FIG. 1 shows the same trace analysis apparatus processing both the trace analysis and the machine learning model for trace generation, in other examples the apparatus 20 running the machine learning model to generate the predicted trace data may be separate from the apparatus which analyses that predicted trace data for making diagnostic deductions. Hence, it is not essential that the analysis program 34 needs to be provided in the same apparatus that runs the machine learning model.

FIG. 2 illustrates a method of processing in an inference phase of the machine learning model. At step 50 the processing circuitry 22 obtains input trace data indicating a sequence of events occurring during execution of the target program on the processor 4. At step 52, the processing circuitry 22 obtains a query input based on the input trace data. In some examples the query input could simply be the raw input trace data itself, but in other examples the query input could be obtained by pre-processing the input trace data (e.g. “tokenising” the input trace data to generate a representation of the input trace data for input to the model), and/or by supplementing the input trace data with other system information, such as providing additional diagnostic information from one or more of the other diagnostic sources 12, 13, 14 mentioned above. At step 54, the query input is provided as an input to the trained generative machine learning model. At step 56, the query input is processed using the trained generative machine learning model, to generate predicted trace data providing a more detailed representation of the sequence of events than is indicated by the input trace data.

FIG. 3 illustrates a method of processing in a training phase of the machine learning model. The training phase can be carried out off-line, in advance of performing the inference phase. It is not essential for the training phase to be carried out by the same device 22 which processes the inference phase. In some cases, the training phase may be carried out by a developer of the machine learning model, and once training is complete the trained model parameters 32 may be stored in the apparatus 20 which will perform the inference phase processing, without further adaptation based on training at the time when the inference phase is processed. However, other examples may continue some training functions in parallel with inference phase, as new examples of trace data are supplied.

In the training phase, at step 60 a generative machine learning model is provided, which is defined by model parameters 32 representing a transformation function for transforming a query input (derived from input trace data) into predicted trace data with a more detailed representation of events than in the input trace data. The model is designed to predict missing information which represents events which occurred during execution of the target program but which could not be represented in the sparse input trace data due to sampling caused by limitations in trace capture bandwidth. At step 62, a training set of trace data sequences is provided. For example, each training trace data sequence could comprise a real set of trace data captured by trace hardware on a processing device 2 (e.g. a device with unusually high amount of trace capture resources making capture of more detailed trace information more feasible than on the majority of devices), or could comprise synthetic or simulated sets of trace data which have been generated by software without actual capture on a hardware device. At step 64, a training function is applied to train the generative machine learning model using the training set of trace data sequences, to generate updated values for the model parameters.

FIG. 4 schematically illustrates the machine learning approach to trace generation in more detail. A trace database 84 is provided that is used for recording and inspection. This can consist of both synthetic (generated) traces as well as (short) instruction traces captured on devices and in simulators. This database is used for training the generative algorithm 80 used for inference.

The generative algorithm 80 itself can be in several forms. Current state of the art utilizes Transformer models for predictions of sequence data, but alternatives like LSTM (Long Short-Term Memory), RNN (Recurrent Neural Networks) or Markov chains could be used. In some cases, the model may be a diffusion model where any of the types of generative algorithms mentioned may be extended by a diffusion process, in which parts of the data get obscured by (Gaussian) noise, after which it is attempted to reconstruct the original signal by denoising the obscured trace. This improves the representativeness of the inferences of the model. Hence, as shown in FIG. 6, a given training data sequence could be degraded (e.g. by removing samples or adding noise), to generate a degraded trace data sequence used for training, and the training function may depend on a comparison between predicted trace data (generated by the machine learning algorithm 80 from the degraded trace data sequence) and the original non-degraded version of the training trace data sequence from which that degraded trace data sequence was generated.

As shown in FIG. 5, the trace database can be extended with additional system information that could help making more informed inferences. For instance, the system information could comprise branch statistics provided by the branch profiling circuitry 12, performance monitoring data captured by performance counters of the performance monitoring circuitry 13, information from profiling records provided by statistical profiling circuitry 14, or other information relating to memory accesses or branch prediction statistics which could provide helpful information for the composition of the code sequence that follows. Additionally, kernel and software stack symbols (information on branch target addresses of taken branch instructions) could be recorded during program execution (either by hardware or with assistance of software such an operating system), to help annotate the branching addresses in the captured trace information. The system information could also include synchronisation information representing a point of program flow reached corresponding to a given packet of the trace stream, which could either be extracted from the trace stream itself or obtained from other sources. This can be correlated with full traces, and this correlation can be useful information during inference. As shown in FIG. 5, one way in which the generative machine learning algorithm could consider additional system information is by forming the query input as a sequence of vectors, each vector comprising a trace data field to provide a trace data element from the input trace data and one or more additional system information fields which may provide associated system information correlated to a given point of the trace stream. Machine learning models which accept sequences of vector inputs are known (e.g. transformers) and could be applied to such a query input. By providing additional system information, the machine learning model has more information available for making better inferences on how to reconstruct the missing trace data when generating the predicted trace data.

As shown in FIG. 4, both the training phase and the inference phase of processing may include a validation process (82 for training, 90 for inference). The validation process provides a set of heuristics that provide requirements, tests or limiters to the generated trace. It may be known a priori what requirements the trace should follow, for instance a list of unrealistic instruction sequences or rules to be satisfied by realistic sequences. Further examples of validation requirements are discussed below.

This validation can be valuable feedback during training, as well as a “litmus test” to see if the trace can be valuable. This validation could be the same during training and inference, or specific requirements could be added to the validation criteria used for inference that were not used in training. During training, the learning algorithm for adapting the stored model parameters based on the training examples may accept a validation parameter set based on whether the predicted trace data generated from a given training example satisfies the validation criteria, so that predictions that do not satisfy the validation criteria are penalised more than predictions that satisfy the validation criteria, making it more likely that following a number of iterations of training, the model parameters are adapted so as to favour predictions that do satisfy the validation criteria.

During inference the trace capture process 86 (e.g. carried out by the trace capture hardware 10 on the apparatus 2 that executes the target program) will sample parts of the trace to the extent of any bandwidth limitations associated with the capturing system. This results in sparse data, which may get enhanced with other information, such as process information (e.g. branch target addresses) or performance measurements provided by circuitry 12, 13, 14. This capture information is fed to the generative algorithm 80 and used to form a query input. By processing the query input using the model algorithm (as defined by the model parameters learnt in training), a fuller trace stream is generated which fills in the gaps. This may be done in one iteration or in multiple denoising iterations with validation 90 against the validation requirements after each iteration. If in a given inference run no valid prediction can be obtained which meets the validation criteria, the model can be controlled to perform another inference or refinement based on the original query, until it generates a predicted trace output that meets the validation requirements. If the trace is found to be correct, a synthetic trace file 92 comprising the successfully validated predicted trace data is returned to the user and/or stored to data storage. The newly generated trace 92 could also potentially be added to the trace database 84 to use for future training of the model.

The trace database 84 can be queried by the user, and can be refreshed based on newly captured training examples even after already performing inference based on the model parameters learnt from previous training examples. This ensures that as time progresses, outdated traces can be cleaned up (updated or removed), and the model can be retrained on a dataset based on more recent activity.

As shown in FIG. 7, for some model types the training process may be based on a sliding window approach, where a single longer trace sequence (e.g. obtained by degrading a fuller sequence as shown in FIG. 6) can be partitioned into multiple (overlapping) separate training examples of shorter length, where an initial portion of the training example is used to form a query input used to predict predicted data for a subsequent window, and the predicted data can be compared against the actual trace data (e.g. the original non-degraded version of the training example) for that subsequent future window of the trace stream and validated to check for realistic trace outputs. For example, for the validation the predicted (more detailed) trace data for the future window of time may be overlaid against the actual trace elements for the corresponding future elements of the degraded training example, to check that the actual elements of the degraded stream generated are still preserved in the predicted stream.

FIGS. 8 and 9 show in more detail examples of applying the validation criteria during inference (FIG. 8) and training (FIG. 9). For the inference phase processing, step 56 of FIG. 2 may comprise the steps 140, 142, 144 shown in FIG. 8. At step 140, the query input is processed using the machine learning model to generate at least one candidate for the predicted trace data. Some model types may generate multiple candidates. For example, a model may generate a ranking or score value for each candidate (expressing a prediction of which candidates are the best), and so may output the N candidates with the highest scores, with N being 1, 2 or more). At step 142, it is determined whether any of the output candidates for the predicted trace data satisfy the one or more validation criteria applied for validation. If none of the candidates output in the current prediction run satisfy the validation criteria, then the method returns to step 140 to re-process the query input using the machine learning model, to generate a new set of candidates (some models may include a random element which means that the generated candidates for a given query input are not always the same, or alternatively the query input may be perturbed slightly between one prediction run and another to try to trigger the model to generate a different set of candidates compared to the previous run). If at least one candidate is identified which does satisfy the validation criteria, then at step 144 the highest ranking candidate that satisfies the validation criteria is output as the predicted trace data to be useful subsequent trace analysis. If no successfully validated prediction is available despite a certain maximum number of attempts at querying the machine learning model having been made, the method may be halted.

The validation criteria may take a variety of forms. For example, any one or more of the following validation criteria could be applied. In general, by applying some rule-based validation constraints, in addition to the data-driven pattern recognition represented by the main machine learning model, the model can be guided to generate more realistic predictions of trace data.

Input preservation criterion: The original sparse trace stream represents events that definitely took place, so should preferably not be removed as a function of the prediction that generates the more detailed trace stream. A comparison of the input trace data and the predicted trace data may be made to detect whether the input trace data has been preserved within the predicted trace data. For example, a scoring function may be applied which determines, for each pair of elements of the input trace data whether that pair of elements is separated by no more than a certain number of intervening elements in the predicted trace data, and generates an “input preservation score” based on such analysis for each successive position within the input stream. The prediction may be considered to pass the validation criterion if this score meets a given threshold criterion based on a comparison with a threshold (depending on the scoring function, the requirement could be either that the score exceeds a threshold or that the score is less than a threshold). For example, for an original input stream with trace packets P1, P2, P3, P4, P5, a prediction of P1, Pa, Pb, P2, Pc, P3, P4, Pd, P5 may be considered to have a better input preservation score than a prediction of P1, Pa, Pb, Pc, Pd, P5 which has caused original trace packets P2, P3, P4 to be dropped and so has lost useful information. It is not essential that every trace element of the input trace data stream has to be preserved in order to pass the input preservation criterion, but the validation process may tend to favour predictions that retain a larger fraction of original elements of the input trace data stream, to increase the likelihood that the predicted trace data output for actual trace analysis is a realistic representation of what happened during execution of the target program.

Source code criterion: the sequence of program flow indicated by the predicted trace data can be compared with the target program code 30 to identify whether the predicted trace data represents a realistic sequence of program flow. For example, for non-looping sequences, if the number of taken branches between two synchronisation points exceeds the number of branches that could actually be executed in that portion of the code, or if the predicted program flow indicates that two sections of code which depend on mutually exclusive conditions was executed, the source code criterion may be considered not to be satisfied. Checking the source code consistency of the trace may also depend on the type of execution/functionality being traced. For instance, highly parallel execution may involve less execution in higher exception levels, fewer interrupts, etc. On the contrary, asymmetric execution may have more interrupt routines, higher exception level execution, etc. Hence, the source code could be analysed to check for entry and exit routines for interrupts, exception levels, power states, etc. and there may be defined testing conditions for the source code available that could be reused as a check. It can be checked that, where the source code indicates that a interrupt entry/exit, change of exception level or change of power state is likely to occur, that such an event does (or could) occur in the trace.

Performance monitoring criterion: The performance count values output by the performance monitoring circuitry 13 during program execution can be compared with the predicted trace data to determine whether the sequence of events indicated by the predicted trace data is inconsistent with the frequency of events indicated by the performance count values. For example, if the instruction execution rate indicated by performance count values is inconsistent with the number of instructions predicted to have executed as indicated by the predicted trace data, then the validation may fail. For example, based on the performance monitoring unit (PMU) values, the validation test may involve playback in a simplified simulator. For performance monitoring information like instruction counts, the evaluation can be more straightforward, but for PMU events like branch statistics, further system knowledge derived from the simulator may be used to determine if the trace sequence is realistic given the specified PMU data.

Instruction composition criterion: Instruction composition information may be available, e.g. based on performance monitoring data from performance monitoring circuitry 13, which expresses the relative frequency of one or more types of instruction among the instructions executed from target program. For example, an indication of the fraction of executed instructions which are load/store instructions or compute instructions may be provided. Based on the instruction composition information, the validation function 82, 90 may determine whether the sequence of events indicated by the predicted trace data is consistent with the instruction composition information. For example, if the predicted trace data indicates that program flow would have traversed sections of code which are dominated by compute instructions but the instruction composition information indicates that actually the executed instructions were dominated by load/store instructions, this validation criterion could be considered not satisfied.

Branch target criterion: Information about branch target addresses of taken branch instructions may be available (e.g. captured in hardware or tracked by an operating system in software). Again, the validation function 82, 90 may determine whether the predicted trace indicates a realistic path that could have been taken given the known branch target addresses that were called, and validation may fail if the sequence represented by the predicted trace information is unrealistic.

Operating state criterion: The input trace stream may include some context information defining a processing context of the executed instructions. For example, the context information may indicate a current operating state (e.g. execution mode, exception level or privilege level) at which the instructions were executed. Hence, if the predicted trace data indicates events which would not be allowed in the current operating state defined by the context information included in the trace stream (e.g. accessing registers associated with an elevated privilege level when executing code in a less privileged operating state that would not be allowed to access those registers), then the predicted trace data could be rejected as failing the validation.

FIG. 9 illustrates an example of applying the training function at step 64 of FIG. 3, during the training phase of processing, when considering validation constraints as discussed above. At step 150, a next training example to be considered for training is selected and used to generate a query input based on the training example. For example, the training example could be degraded and/or could be supplemented with system information as described earlier. At step 152, the query input is processed using the machine learning model based on the current values for its model parameters, to generate corresponding predicted trace data.

At step 154, the validation function 82 determines whether the predicted trace data satisfies validation criteria. It is not necessary for the validation function 82 used during the training phase to consider all of the validation criteria which may be applied for the validation function 90 used during the inference phase, as some of the ancillary information used for validation (e.g. the performance monitoring data, branch target information and/or instruction composition information) may be captured only during the trace capture process 86 but may not be provided in association with each training example. However, by applying at least one validation criterion during training it is possible to adapt the model parameters to increase the likelihood that predictions can be made which satisfy the validation criteria that will be applied during inference. Any one or more of the validation criteria mentioned above could be applied.

At step 156 a loss function is determined based on a comparison of the predicted trace data and expected trace data corresponding to the query input. For example, the expected trace data could be the non-degraded version of the degraded training data used to form the query input, or could be actual trace data from a training sequence, which corresponds to the future window of the trace stream for which the predicted trace data was generated based on input trace data for an earlier window of the trace stream. The loss function may quantify deviation of the predicted trace data from the expected trace data, but may also introduce a parameter which penalises predictions of trace data that do not satisfy the validation criteria applied at step 154 and rewards predictions that do satisfy the validation criteria. For example, a loss function commonly used in transformer models or other models can be used, such as cross-entropy loss for example. This loss function can be enhanced by any metrics that were provided by the validation function. For instance, a sequence with a certain number of branches may look realistic from the base loss function, however looking at the total number of branches over time during the validation step this may deviate more than a predetermined realistic amount. A penalty can then be applied to the suggestions (akin to reinforcement learning), such that only the more likely one will be selected the following time. This penalty could be higher depending by how much the number of branches overshot (e.g. difference squared).

At step 158, the model parameters are adjusted based on the loss function. In general, the adjustments to the model parameters may be greater if the loss function indicates that the predicted trace data deviate significantly from the expected trace data or does not satisfy the validation criteria, than if the predicted trace data is more similar to the expected trace data or does satisfy the validation criteria. The adaptation of the model parameters may aim to increase the likelihood that future predictions based on the adjusted model parameters are more likely to cause predictions to correspond to their expected trace data and/or satisfy the validation parameters. The particular function for adapting the model parameters may depend on the type of machine learning model used (e.g. gradient descent based algorithms).

At step 160, it is determined whether a training end condition is satisfied. For example, the training end condition may be determined to be satisfied once a certain number of training examples have been processed (or if there are no training examples left to process), or once the average loss function calculated for a given number of training examples meets a certain condition, or once validation has been passed for the predictions generated from a certain number of successive training examples. If the training end condition is not yet satisfied, the method returns to step 150 to process another training example. Once the training end condition is satisfied, at step 162 training phase is halted and the adapted model parameters resulting from training are stored for future use during inference.

FIG. 10 illustrates a potential implementation of the trace generation model. This implementation is based on a transformer architecture, although it will be appreciated that other machine learning model algorithms can also be used. As shown in FIG. 10, the model comprises an encoder 200 and decoder 202. These networks can be trained unsupervised on sequential data and have been proven to be effective for natural language processing tasks—as they are used to make predictions based on sequential series of symbols they are well suited to the problem of processing an input series of trace data to predict more detailed trace data. In the encoder and decoder networks 200, 202 the following layers can be found:
Input and output layers 204, 214: These layers take a representation of the data. The output 214 is fed into the decoder part 202 of the network, but shifted relative to the input 204 provided to the encoder part 200, allowing the network to see the context of what it has previously generated. For instance, say the sentence “Arm is a cool company to work for” is being generated, and the network is generating the fifth word (company) in that sentence, then the output (shifted) could be: “Arm is a cool”. When applied to the trace generation example, this can help implement the sliding window training approach discussed earlier with respect to FIG. 7 where the query input (supplied in the output layer 214 of the decoder 202) is based on trace data for an earlier window of time and the expected data for comparison used as input for the input layer 204 is for a later window of time to allow for comparison with the output layer 224's predicted output.
Positional encoding 210, 216: These represent the position in the corpus and are needed as the network has no recurrent properties to keep track of where in relation to the other data the input is. This is encoded as a vector which accompanies the input vector.
Multi-head attention layer 208, 218: These layers track the relation between occurrences in a sequence, and how much emphasis they put on other parts of the sequence. In the decoder part of the model there is a “Masked” version of this layer referenced. This is typically used during training, to parallelize the generation (as you have the correct prediction already) and not accumulate the error. This masking is typically used to prevent using the information in the self-attention that you do not have yet.
Feed forward and normalization layer 212, 222: these are a set of convolutional, residual and ReLu (Rectified Linear Unit) layers which normalize the result. At the end there is usually a SoftMax layer that generates a probability distribution which helps indicate which prediction is most likely. The highest likelihood is the prediction picked, but alternatively several options could be listed (as mentioned above generating multiple candidates for the predicted trace can be helpful to provide more options which could satisfy the validation criteria).

For a generative network, typically the decoder part 202 is taken from this solution and used after training (hence the encoder part 200 does not form part of the inference phase processing but is used only in training). However, if the encoder part 200 is provided in the device that performs the inference phase, the decoder part 202 can be further trained.

The transformer model would be trained on a large body of traces or trace fragments that have been previously captured or generated. This will uncover common patterns of instructions and train a general structure that can be seen in various traces. The model can be further tweaked and trained over time.

For inference, the known part of the trace will be given as a prompt, and the model will be queried to fill in the missing data. If we have captured a trace with sparse data points and intervals that need to be predicted, we could make use of the masked multi-head attention layer 218 to suppress the unknown positions.

FIG. 11 shows use of multiple iterations of the inference phase to refine the predicted trace data. A given query input generated based on input trace data may be supplied to the machine learning model and the prediction of the model validated. When a successfully validated set of predicted state data is obtained, this may be supplied as the input trace data for forming a further query input which can be passed through the model again. After a given number of iterations, the predicted trace data from the final iteration may be output for trace analysis. This approach may be helpful because injecting a large amount of predicted trace data into the trace stream in a single step may have greater risk of “hallucination” than if a smaller amount of trace data is injected at each iteration. By performing validation after each iteration, the trace data injected at a given iteration can be inspected to check it is realistic before further refining the predicted trace data to add more detail in a subsequent iteration.

FIG. 12 shows how multiple trained models could be applied in parallel or sequentially to the same query input, to generate a set of candidates for the predicted trace data which are subject to the validation processing and used to select the predicted trace data to be used for subsequent trace analysis. Each of the respective trained models used could differ in terms of the machine learning algorithm used (e.g. one RNN and one Transformer model), and/or could differ in terms of the set of training data that was used to train the model. For example, it might be useful to train multiple instances of the same kind of model on trace data derived from different kinds of software workloads (e.g. one training set based on tracing events during a compute-heavy workload and another training set based on tracing events during a memory-heavy workload). By providing a number of models which have different strengths and weaknesses and running the same query input through each model, it is more likely that an acceptable prediction passing the validation requirements can be found.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Various examples are set out in the following clauses:
1. A method for trace generation, comprising:
   obtaining input trace data indicative of a sequence of events occurring during execution of a target program on a processor;
   providing a query input to a trained generative machine learning model, where the query input is based on the input trace data; and
   processing the query input using the trained generative machine learning model to generate predicted trace data providing a more detailed representation of the sequence of events than is indicated by the input trace data.
2. The method of clause 1, in which the input trace data is indicative of a sampled subset of events occurring during execution of the target program on the processor, and the trained generative machine learning model predicts missing events that occurred during execution of the target program but were omitted from the input trace data due to sampling.
3. The method of any of clauses 1 and 2, in which the input trace data comprises instruction trace data providing program flow information indicative of which instructions were executed during execution of the target program on the processor.
4. The method of any preceding clause, in which the input trace data is trace data captured using trace capture hardware configured to monitor operation of the processor during execution of the target program.
5. The method of any preceding clause, in which the query input also comprises system information captured during execution of the target program on the processor.
6. The method of clause 5, in which the query input comprises a sequence of vectors, each vector comprising an item of trace data from the input trace data and at least one system information field for associating at least one item of system information with that item of trace data.
7. The method of any of clauses 5 and 6, in which the system information comprises synchronisation information for synchronising items of trace data of the input trace data with a point of execution of the target program.
8. The method of any of clauses 5 to 7, in which the system information comprises at least one of:
   performance monitoring information captured by one or more performance monitoring counters of the processor during execution of the target program on the processor, and
   profiling information indicative of system behaviour associated with execution of a sampled instruction selected for profiling.
9. The method of any of clauses 5 to 7, in which the system information comprises at least one of:
   branch statistic information providing a statistical measure of behaviour of branch instructions of the target program, and
   branch target address information indicative of target addresses of branches taken during execution of the target program.
10. The method of any preceding clause, comprising:
   validating whether the predicted trace data meets at least one validation criterion for checking whether the predicted trace data is realistic; and
   in response to determining that one or more items of predicted trace data generated by the trained generative machine learning model each fail the at least one validation criterion, re-processing the query input using the trained generative machine learning model to generate one or more new instances of the predicted trace data.
11. The method of clause 10, in which the at least one validation criterion includes an input preservation criterion to determine, based on a comparison of the input trace data and the predicted trace data, whether the input trace data has been preserved within the predicted trace data.
12. The method of any of clauses 10 and 11, in which the at least one validation criterion includes a source code criterion to determine, based on source code of the target program, whether the sequence of events indicated by the predicted trace data is consistent with a realistic program flow path that could be taken when executing the target program defined by source code.
13. The method of any of clauses 10 to 12, in which the at least one validation criterion includes a performance monitoring counter criterion to determine, based on at least one performance monitoring count value indicative of frequency of a given event during execution of the target program, whether the sequence of events indicated by the predicted trace data is consistent with the at least one performance monitoring count value.
14. The method of any of clauses 10 to 13, in which the at least one validation criterion includes an instruction composition criterion to determine, based on instruction composition information indicative of relative frequency of one or more types of instruction among the instructions executed for the target program, whether the sequence of events indicated by the predicted trace data is consistent with the instruction composition information.
15. The method of any of clauses 10 to 14, in which the at least one validation criterion includes a branch target criterion to determine, based on branch target information indicative of target addresses of taken branch instructions executed for the target program, whether the sequence of events indicated by the predicted trace data is consistent with the branch target information.
16. The method of any of clauses 10 to 15, in which the at least one validation criterion includes an operating state criterion to determine, based on context information indicative of a current operating state associated with a portion of the input trace data, whether a corresponding portion of the predicted trace data indicates events that would not be allowed in the current operating state.
17. The method of any preceding clause, in which the predicted trace data is generated through multiple iterations of processing by the trained generative machine learning model, where output trace data generated for a given iteration of processing is input as the query input for a further iteration of processing by the trained generative machine learning model.
18. The method of clause 17, in which the output trace data generated for the given iteration of processing is validated to check whether it meets at least one validation criterion for checking whether the output is realistic, before inputting the validated output trace data as the query input for the further iteration.
19. The method of any preceding clause, in which a plurality of trained generative machine learning models are provided based on different prediction functions and/or different sets of training data; and
   the method comprises selecting between predicted trace data generated by at least two of the trained generative machine learning models supplied with the same query input, based on validation of the outputs of said at least two of the trained generative machine learning models.
20. A method for training a generative machine learning model for trace generation, the method comprising:
   providing a generative machine learning model defined by model parameters representing a transformation function for transforming a query input into predicted trace data, where the query input is based on input trace data indicative of a sequence of events occurring during execution of a target program on a processor, and the predicted trace data provides a more detailed representation of the sequence of events than is indicated by the input trace data;
   providing a training set of trace data sequences, each trace data sequence indicative of a sequence of events occurring during actual or simulated execution of a target program on a processor; and
   applying a training function to train the generative machine learning model using the training set of trace data sequences, to generate updated values for the model parameters.
21. The method of clause 20, comprising generating, for each trace data sequence of the training set, one or more degraded trace data sequences representing the sequence of events in less detail than that trace data sequence;
   wherein the training function comprises, for a given degraded trace data sequence:
      applying the transformation function to the given degraded trace data sequence, to generate a given predicted trace data sequence; and
      adjusting the model parameters based on a comparison of the given predicted trace data sequence with a corresponding trace data sequence of the training set from which the given degraded trace data sequence was derived.
22. The method of clause 20, wherein the training function comprises, for a given trace data sequence of the training set:
   applying the transformation function to a window of trace data from the given trace data sequence, to generate predicted trace data for a following window; and
   adjusting the model parameters based on a comparison of the predicted trace data for the following window with actual trace data indicated by the given trace data sequence for the following window.
23. The method of any of clauses 20 to 22, in which the training function is also dependent on an outcome of validating whether the predicted trace data meets at least one validation criterion for checking whether the predicted trace data is realistic.
24. A program comprising instructions which, when executed on a data processing apparatus, cause the data processing apparatus to perform the method of any preceding clause.
25. An apparatus comprising:
   input circuitry to obtain input trace data indicative of a sequence of events occurring during execution of a target program on a processor; and
   processing circuitry to provide a query input to a trained generative machine learning model, where the query input is based on the input trace data, and process the query input using the trained generative machine learning model to generate predicted trace data providing a more detailed representation of the sequence of events than is indicated by the input trace data.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A method for trace generation, comprising:
obtaining input trace data indicative of a sequence of events occurring during execution of a target program on a processor;
providing a query input to a trained generative machine learning model, where the query input is based on the input trace data; and
processing the query input using the trained generative machine learning model to generate predicted trace data providing a more detailed representation of the sequence of events than is indicated by the input trace data.

2. The method of claim 1, in which the input trace data is indicative of a sampled subset of events occurring during execution of the target program on the processor, and the trained generative machine learning model predicts missing events that occurred during execution of the target program but were omitted from the input trace data due to sampling.

3. The method of claim 1, in which the input trace data comprises instruction trace data providing program flow information indicative of which instructions were executed during execution of the target program on the processor.

4. The method according to claim 1, in which the input trace data is trace data captured using trace capture hardware configured to monitor operation of the processor during execution of the target program.

5. The method according to claim 1, in which the query input also comprises system information captured during execution of the target program on the processor.

6. The method of claim 5, in which the query input comprises a sequence of vectors, each vector comprising an item of trace data from the input trace data and at least one system information field for associating at least one item of system information with that item of trace data.

7. The method of claim 5, in which the system information comprises synchronisation information for synchronising items of trace data of the input trace data with a point of execution of the target program.

8. The method of claim 5, in which the system information comprises at least one of:
performance monitoring information captured by one or more performance monitoring counters of the processor during execution of the target program on the processor, and
profiling information indicative of system behaviour associated with execution of a sampled instruction selected for profiling.

9. The method of claim 5, in which the system information comprises at least one of:
branch statistic information providing a statistical measure of behaviour of branch instructions of the target program, and
branch target address information indicative of target addresses of branches taken during execution of the target program.

10. The method according to claim 1, comprising:
validating whether the predicted trace data meets at least one validation criterion for checking whether the predicted trace data is realistic; and
in response to determining that one or more items of predicted trace data generated by the trained generative machine learning model each fail the at least one validation criterion, re-processing the query input using the trained generative machine learning model to generate one or more new instances of the predicted trace data.

11. The method of claim 10, in which the at least one validation criterion includes an input preservation criterion to determine, based on a comparison of the input trace data and the predicted trace data, whether the input trace data has been preserved within the predicted trace data.

12. The method of claim 10, in which the at least one validation criterion includes a source code criterion to determine, based on source code of the target program, whether the sequence of events indicated by the predicted trace data is consistent with a realistic program flow path that could be taken when executing the target program defined by source code.

13. The method of claim 10, in which the at least one validation criterion includes a performance monitoring counter criterion to determine, based on at least one performance monitoring count value indicative of frequency of a given event during execution of the target program, whether the sequence of events indicated by the predicted trace data is consistent with the at least one performance monitoring count value.

14. The method of claim 10, in which the at least one validation criterion includes an instruction composition criterion to determine, based on instruction composition information indicative of relative frequency of one or more types of instruction among the instructions executed for the target program, whether the sequence of events indicated by the predicted trace data is consistent with the instruction composition information.

15. The method of claim 10, in which the at least one validation criterion includes a branch target criterion to determine, based on branch target information indicative of target addresses of taken branch instructions executed for the target program, whether the sequence of events indicated by the predicted trace data is consistent with the branch target information.

16. The method of claim 10, in which the at least one validation criterion includes an operating state criterion to determine, based on context information indicative of a current operating state associated with a portion of the input trace data, whether a corresponding portion of the predicted trace data indicates events that would not be allowed in the current operating state.

17. The method according to claim 1, in which the predicted trace data is generated through multiple iterations of processing by the trained generative machine learning model, where output trace data generated for a given iteration of processing is input as the query input for a further iteration of processing by the trained generative machine learning model.

18. A method for training a generative machine learning model for trace generation, the method comprising:
providing a generative machine learning model defined by model parameters representing a transformation function for transforming a query input into predicted trace data, where the query input is based on input trace data indicative of a sequence of events occurring during execution of a target program on a processor, and the predicted trace data provides a more detailed representation of the sequence of events than is indicated by the input trace data;
providing a training set of trace data sequences, each trace data sequence indicative of a sequence of events occurring during actual or simulated execution of a target program on a processor; and
applying a training function to train the generative machine learning model using the training set of trace data sequences, to generate updated values for the model parameters.

19. The method of claim 18, comprising generating, for each trace data sequence of the training set, one or more degraded trace data sequences representing the sequence of events in less detail than that trace data sequence;
wherein the training function comprises, for a given degraded trace data sequence:
applying the transformation function to the given degraded trace data sequence, to generate a given predicted trace data sequence; and
adjusting the model parameters based on a comparison of the given predicted trace data sequence with a corresponding trace data sequence of the training set from which the given degraded trace data sequence was derived.

20. A program comprising instructions which, when executed on a data processing apparatus, cause the data processing apparatus to perform the method according to claim 1.

21. An apparatus comprising:
input circuitry to obtain input trace data indicative of a sequence of events occurring during execution of a target program on a processor; and
processing circuitry to provide a query input to a trained generative machine learning model, where the query input is based on the input trace data, and process the query input using the trained generative machine learning model to generate predicted trace data providing a more detailed representation of the sequence of events than is indicated by the input trace data.
